(19) United States
(12) Patent Application Publication
(10) Pub. No.: US 2009/0265207 A1
(43) Pub. Date: Oct. 22, 2009

(54) Property Management System and Method for Operating the Same

(75) Inventor: Brandon T. Johnson, St. Clair Shores, MI (US)

Correspondence Address: HONIGMAN MILLER SCHWARTZ & COHN LLP, 38500 WOODWARD AVENUE, SUITE 100, BLOOMFIELD HILLS, MI, 48304-5048, US

(73) Assignee: GTJ Consulting LLC, Roseville, MI (US)

(21) Appl. No.: 12/107,425

(22) Filed: Apr. 22, 2008

(51) Int. Cl. G06Q 10/00

(52) U.S. Cl. 705/9

(57) ABSTRACT

A method for operating a property management system is disclosed. The method includes the steps of identifying one or more maintenance needs of one or more real property units; and utilizing a communication device for creating one or more virtual work orders related to the one or more maintenance needs, uploading one or more maintenance need images associated with the one or more virtual work orders, and uploading one or more serviced task images associated with the one or more virtual work orders. A system is also disclosed.

### TECHNICAL FIELD

The invention relates in general to a property management system and a method for operating the same.

### BACKGROUND

During an ownership period of one or more real property units, a person or business entity may have to attend to one or more maintenance needs of the one or more real property units. Upon identifying the one or more maintenance needs, it may be difficult to determine the progress/completion of one or more tasks associated with the one or more maintenance needs.

In view of the above drawbacks and for other reasons, a need exists in the art for a system and method for assisting a person or business entity in the management of one or more maintenance needs associated with one or more real property units.

### BRIEF DESCRIPTION OF THE DRAWINGS

The disclosure will now be described, by way of example, with reference to the accompanying drawings, in which:

FIG. 1A is a plan view of a property management system in accordance with an exemplary embodiment of the invention;

FIG. 1B is a plan view of a property management system in accordance with an exemplary embodiment of the invention;

FIGS. 2A-2C illustrate a method for operating a property management system in accordance with an exemplary embodiment of the invention; and

FIGS. 3-8 illustrate portions of the property management system in accordance with an exemplary embodiment of the invention.

### DETAILED DESCRIPTION

The Figures illustrate an exemplary embodiment of a property management system and a method for operating the same in accordance with an embodiment of the invention. Based on the foregoing, it is to be generally understood that the nomenclature used herein is simply for convenience and the terms used to describe the invention should be given the broadest meaning by one of ordinary skill in the art.

I. System Overview

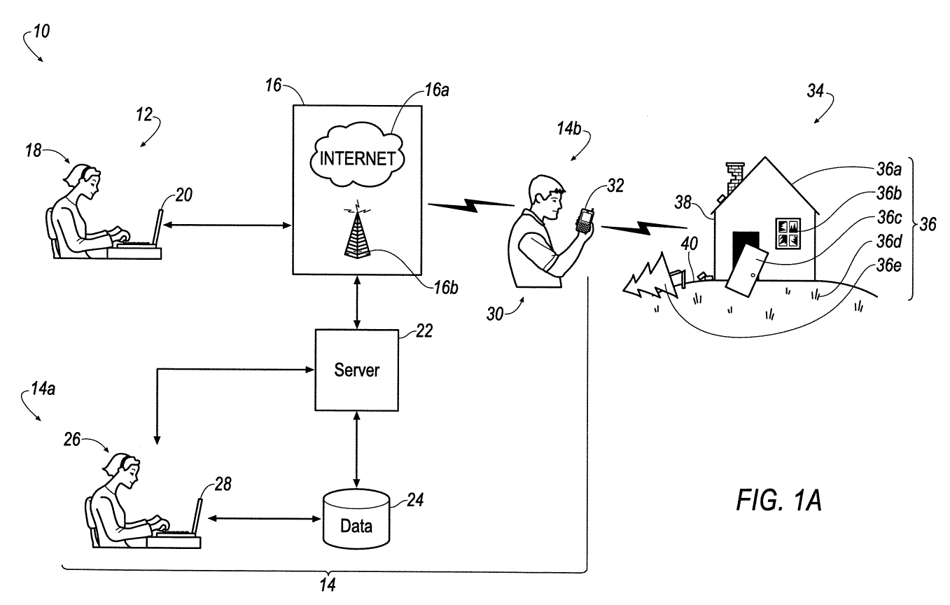

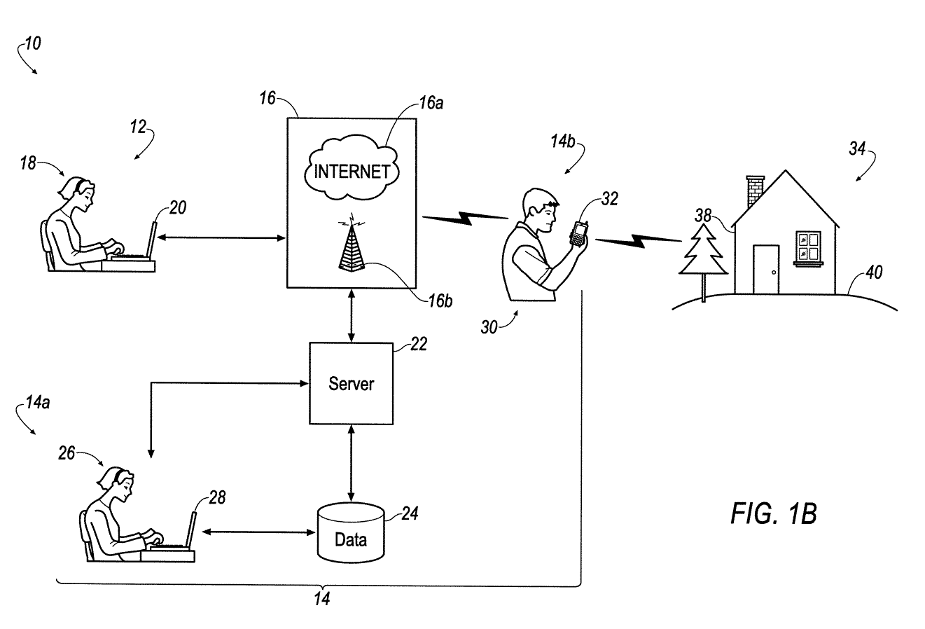

Referring to FIG. 1A, a property management system is shown generally at 10 according to an embodiment. The property management system 10 is generally defined by a client portion 12, a local administrator portion 14a and a remote administrator portion 14b. Although shown as two separate portions, the local and remote administrator portions 14a, 14b may be referred to collectively as the administrator portion 14.

A provider is shown generally at 16 and permits the portions 12-14b to communicate with one another. The provider 16 may include, but is not limited to, an Internet service provider (ISP) 16a, a land-line or mobile cell phone service provider 16b, or the like. Accordingly, the portions 12-14b may communicate with one another via audio carried over land-line/cell phone providers 14b, and/or streaming audio via the ISP 16a and/or data posted to a website via the ISP 16a.

In an embodiment, at the client portion 12, a client is shown generally at 18 and a communication device is shown generally at 20. The communication device 20 may include, but is not limited to, a desktop/laptop computer terminal, or, alternatively, a mobile, hand-held device, such as, for example, a cell phone, personal digital assistance (PDA), or the like.

In an embodiment, at the local administrator portion 14a, a server is shown generally at 22 and a database is shown generally at 24. Further, in an embodiment, the local administrator portion 14a may include a local agent, which is shown generally at 26, and a communication device, which is shown generally at 28.

Although the server 22 and database 24 are shown at the local administrator portion 14a, it will be appreciated that the server 22 and database 24 may be remotely located with respect to the local administrator portion 14a, and, for illustrative purposes, the server 22 and database 24 are shown proximate the local administrator portion 14a in order to demonstrate that the contents of the server 22 and database 24 are associated with, owned, leased, and/or otherwise primarily controlled by the administrator portion 14.

In an embodiment, at the remote administrator portion 14b, a remote agent is shown generally at 30 and a communication device is shown generally at 32. Similarly described above with respect to the client portion 12, the communication devices 28, 32 at the administrator portion 14 may include but is not limited to a desktop/laptop computer terminal, or, alternatively, a mobile, hand-held device, such as, for example, a cell phone, PDA, or the like.

In an embodiment, the communication device 32 may include, for example, an imaging function/feature, such as, for example, an integrated and/or stand-alone digital camera that may capture images. Further, it will be appreciated that the communication devices 20, 28, 32 may be utilized as a means for sending, receiving, transferring, accessing, uploading, downloading, and/or otherwise manipulating text, images or any type of data within the system 10.

It will be appreciated that the terms “local” and “remote,” as applied to the administrator portion 14, should not limit the invention, but, rather, is utilized for illustrative convenience in an exemplar embodiment of the invention. For example, the “local” agent 26 may be located at, for example, a brick-and-mortar central office or “home base” whereas the “remote” agent 30, for example, may be located away from the brick-and-mortar central office. In an embodiment, the remote agent 30 may be located “on-site” or proximate a location 34 remote from the central office such that the remote agent 30 may conduct business or a form of work away from the central office.

Accordingly, in the above example, in an embodiment, the remote agent 30 may be an employee of the local agent 26 that dispatches the remote agent 30 to the location 34. Alternatively, in another embodiment, the remote agent 30 may be a contracted person that is hired by the local agent 26. In either embodiment, irrespective of the employment agreement between the remote agent 30 and the local agent 26, it will be appreciated that the remote agent 30 is associated with the administrator portion 14 of the system 10.

In an embodiment, the location 34 may generally include, but is not limited to, one or more real property units. In an embodiment, one or more the client 18 and agents 26, 30 may be a stakeholder that is associated with the one or more real property units 34. In an embodiment, one or more of the client 18 and agents 26, 30 may have an ownership interest in the one or more real property units 34. In an embodiment, the one or more real property units 34 may be one or more foreclosed real property units.

Although the client 18 and agent 26 are generally represented as persons, the client 18 and/or agent 26, may, in general, be a business entity, such as, for example, a bank or real estate business. As such, the person shown generally at 18 and 26 may be a representative of the bank or real estate business.

In the forgoing description, an embodiment of the invention is described such that the person/bank 18 is the owner of one or more foreclosed real property units 34 and the agents 26, 30 represent a company that hosts services for managing, servicing, and/or maintaining the one or more real property units 34. Although the foregoing description is directed to the above-identified embodiment, it will be appreciated that the invention is not limited to this embodiment and that any desirable person or business entity may be represented at 18, 26 and 30. Further, in an embodiment, it will be appreciated that each of the persons 18, 26 and 30 may have a common employer generally defined as an organization such that the portion 12 of the organization is serviced by the portion 14 of the organization.

In all likelihood, it will be appreciated that a repossessed/foreclosed unit of real property 34 may include one or more maintenance needs, which are shown generally at 36. In an embodiment, the one or more maintenance needs are shown in more detail generally at 36a-36e. The one or more maintenance needs 36a-36e may include, but is not limited to, roof damage 36a, broken windows 36b, an unhinged/unsecured door 36c, over-grown grass/landscaping 36d, dead/severed trees 36e or the like.

Although the one or more maintenance needs 36a-36e are shown generally as exterior needs relative a housing unit 38 located on land 40, it will be appreciated that the one or more maintenance needs 36a-36e may also include structural maintenance needs associated with the interior of the housing unit 38. For example, the one or more structural maintenance needs 36 associated with the interior of the housing unit 38 may include but is not limited to plumbing/sewer issues, electrical issues, lighting/fixture issues, blind/curtain issues, wallboard/plaster issues, paint/wallpaper issues, carpet/hardwood floor issues, rodent infestation/animal control issues, appliance issues, mold issues, radon issues, asbestos issues, or the like. Although the above exterior/interior maintenance needs 36 are described above, it will be appreciated that the system 10 is not limited to the above-identified potential maintenance needs 36 and that any desirable maintenance need 36 may be considered by the system 10.

Further, if, for example, a real property unit 34 has been recently repossessed, it will be appreciated that the maintenance need 36c may include, for example, a change of the lock on the door. Further, if, for example, a real property unit 34 is the victim of arson, the maintenance need 36 may include, for example, the inspection and addressing of fire/smoke damage to the structure of the housing unit 38. Accordingly, it will be appreciated that the property management system 10 is not limited to a particular maintenance need 36 and that any desirable maintenance need 36 may be addressed by the system 10.

Thus, if the client 18 has an ownership interest in one or more real property units 34 having one or more maintenance needs 36, it will be appreciated that it may be difficult to determine the number of maintenance needs 36 associated with a plurality of real property units 34, and, once the number of maintenance needs 36 are identified, it may be further difficult to track the progress/completion of one or more tasks associated with resolution of the identified maintenance needs 36. The present system 10 overcomes these difficulties.

II. System Operation

In an embodiment, the system 10 may operate as follows. In general, the client portion 12 may engage the administrator portion 14 for services. In an embodiment, the services to be performed by the administrator portion 14 may include, but is not limited to the identification of maintenance needs 36 and the managing, conducting and/or contracting of tasks associated with the resolution of the maintenance needs 36 such that the unit of real property is changed from a damaged state (i.e., see FIG. 1A) to a repaired state (i.e., see FIG. 1B).

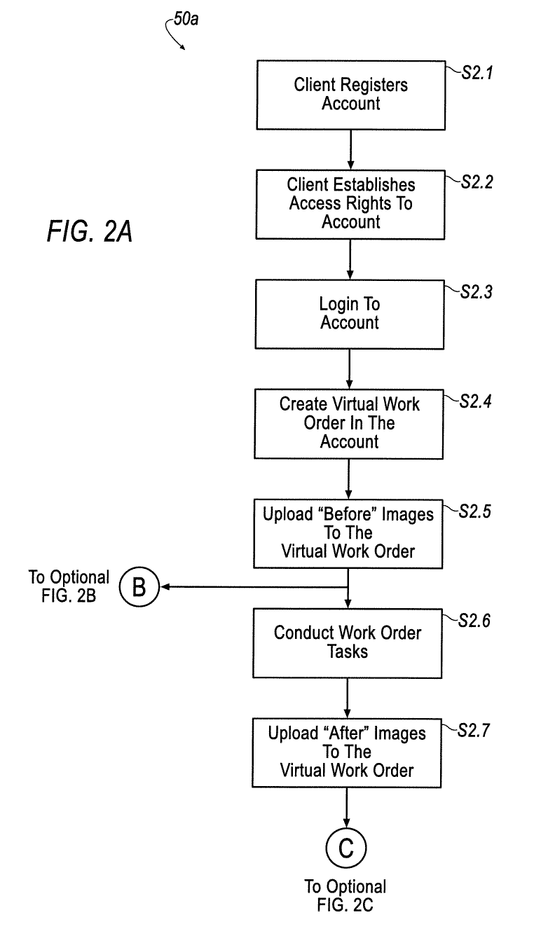

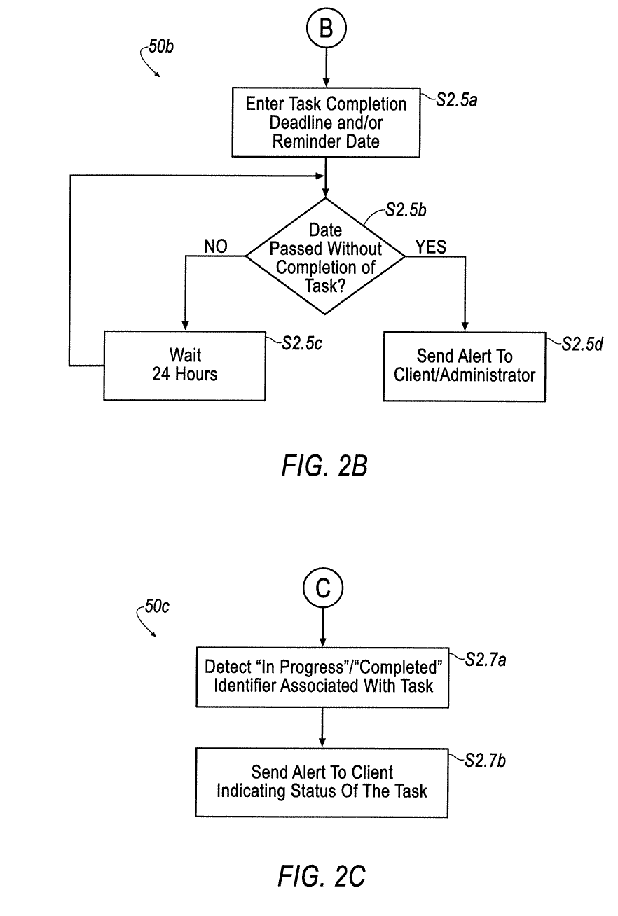

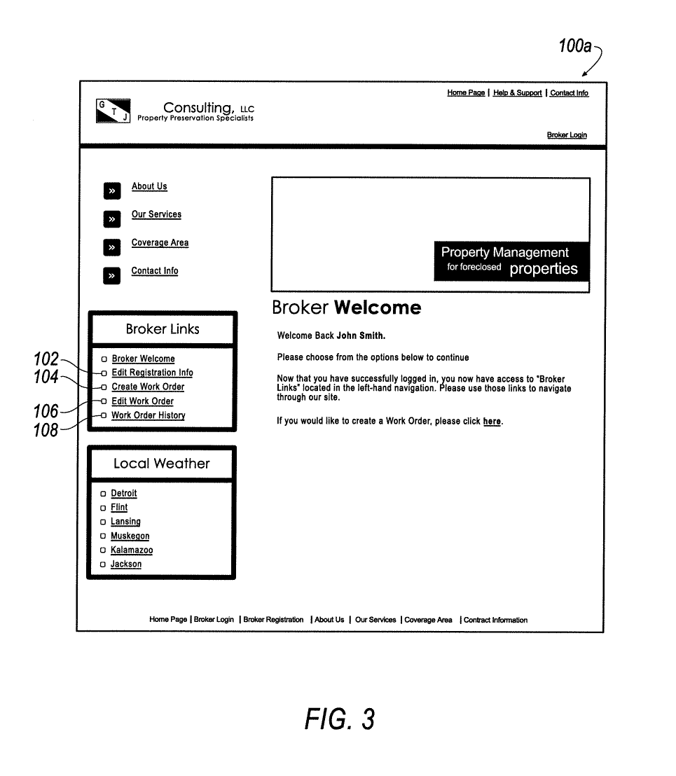

In general, the administrator portion 14 owns and/or operates a website hosted by the server 22. The website may include one or more pages, which are shown, in an embodiment, at 100a-100h in FIGS. 3-8. A method 50a, 50b, 50c associated with the operation of the system 10/pages 100a-100h is shown generally a FIGS. 2A-2C.

In an embodiment, the system 50a-50c/pages 100a-100h may permit one or more of the client portion 12 and/or administrator portion 14 access to data associated with the maintenance needs 36. In an embodiment, the data may be stored in the database 24. In an embodiment, the data may be collaboratively edited by one or more of the client portion 12 and administrator portion 14 such that all parties having access rights to the data may easily determine the progress of one or more tasks that (a) have not been completed, (b) is in the process of being completed, and (c) have been completed in order to resolve the maintenance needs 36.

A. Registering An Account

In order for the client portion 12 to subscribe to the above-identified services to be performed by the administrator portion 14, in a first step (i.e., S2.1 in FIG. 2A), the client 18 may contact the administrator portion 14 in order to register an account with the administrator portion 14. In an embodiment, the registering step may be conducted between the persons 18 and 26 or 30 via phone or email. Alternatively, in an embodiment, as seen in FIG. 3, the client 18 may access a public page 100a of the administrator portion's website by manually entering data (e.g. billing data and/or contact information) to the database 24. In an embodiment, the manually entering data step discussed above may be conducted by “clicking on” (i.e. selecting) an “Edit Registration Info” link 102 on the page 100a.

Further, the public page 100a may include several other links including, but not limited to a “Create Work Order” link 104, an “Edit Work Order” link 106 and a “Work Order History” link 108. It will be appreciated, however, that access to portions of the website that arises from selecting one or more of the links 102-108 may be privately accessible upon entering a username and password, which is discussed below. Further, although four links 102-108 are identified on the page 100a, it will be appreciated that the invention is not limited to the above-identified links 102-108 and that any suitable link may be included on the page 100a as desired.

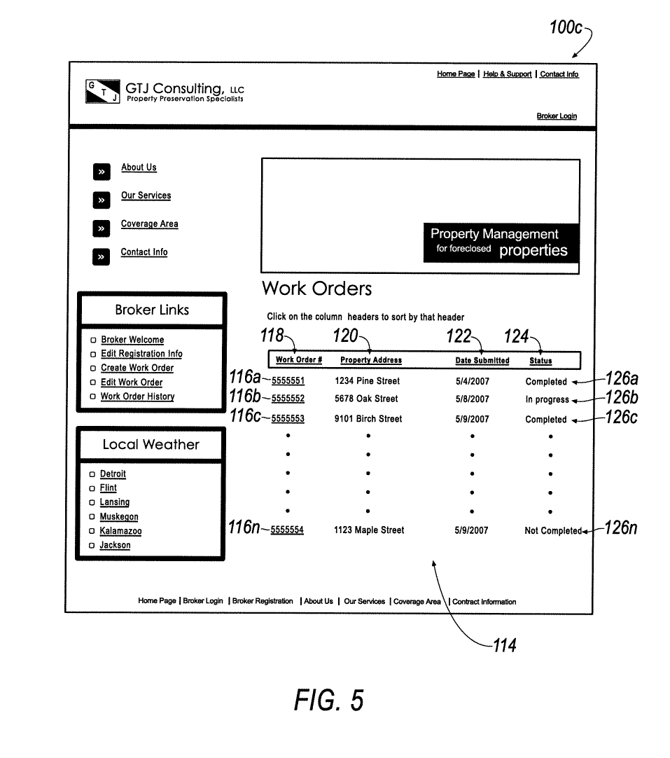

Then, during the registering of the account, the client 18 establishes access rights (step S2.2) to private pages of the website, which are shown generally at 100c-100h in FIGS. 5-8. The private access rights may be associated with access to information to be stored on the database 24. The contents of the database 24 may be accessible by way of the website that is hosted by the server 22. In order to establish the private access rights, the website may query the client 18 for a username and password that is to be stored in the database 24.

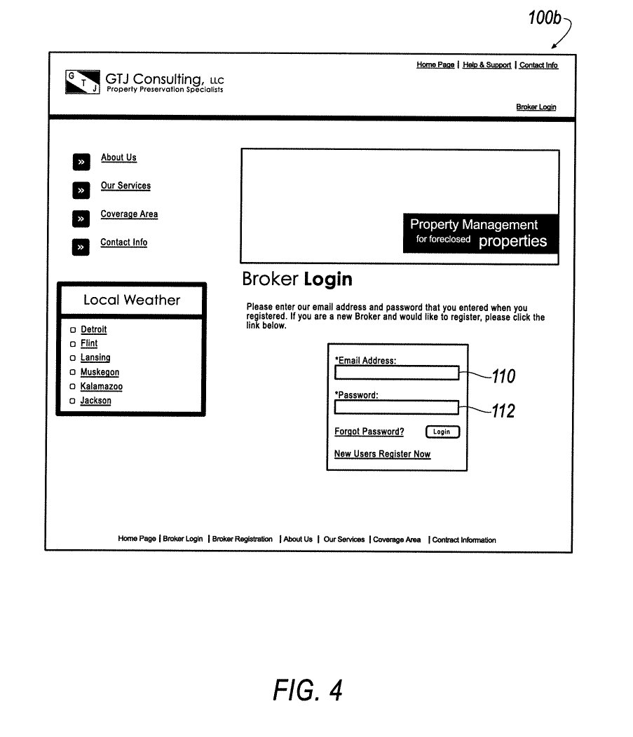

Once access rights are established in the registration step, the client 18 may then login (step S2.3) to the website in order to gain access to the private pages 100c-100h by entering the username and password in a public page 100b shown in FIG. 4. As seen in FIG. 4, in an embodiment, the client 18 may enter a username name and password in data fields 110, 112. In an embodiment, the username may be an email address.

B. Creating Virtual Work Orders

Then, depending on the desires of the client 18, one or more of the client 18 and agent 26, 30 may create one or more virtual work orders (step S2.4) associated with one or more maintenance needs 36 of one or more real property units 34 in/to the database 24 by way of the server 22. Referring to FIG. 3, the above described step may be conducted by selecting the “Create Work Order” link 104 from page 100a of the website.

If desired, the client 18 may request that an agent 26, 30 of the administrator portion 14 investigate the one or more property units 34 and independently identify the one or more maintenance needs 36; once the more or more maintenance needs 36 have been identified, the agent 26, 30 may manually create the one or more virtual work orders associated with one or more maintenance needs 36 of the one or more property units 34 in/to the database 24 by gaining access to the client's registered account and selecting the “Create Work Order” link 104 from the page 100a.

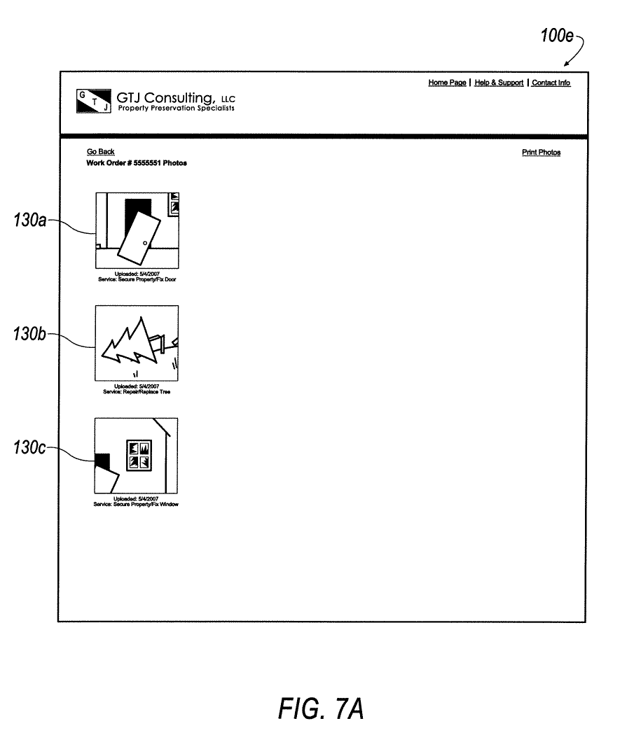

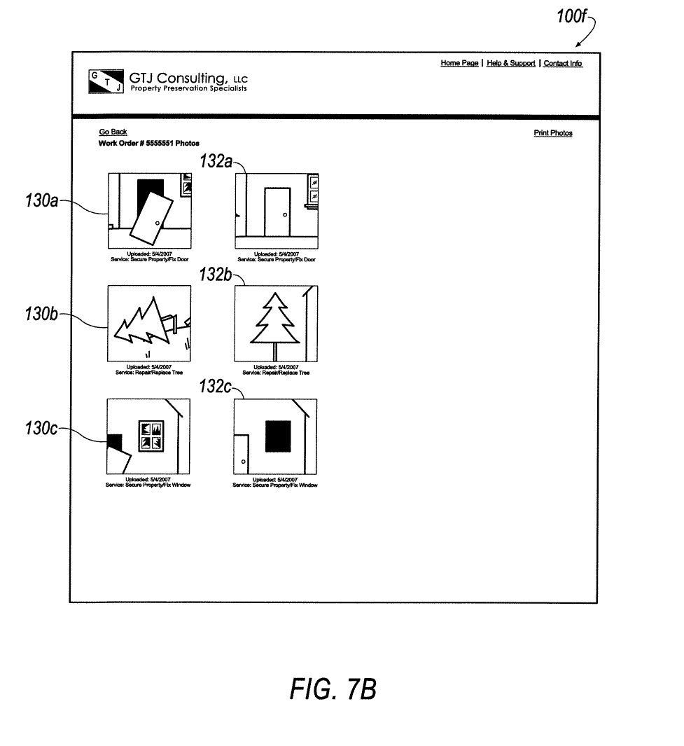

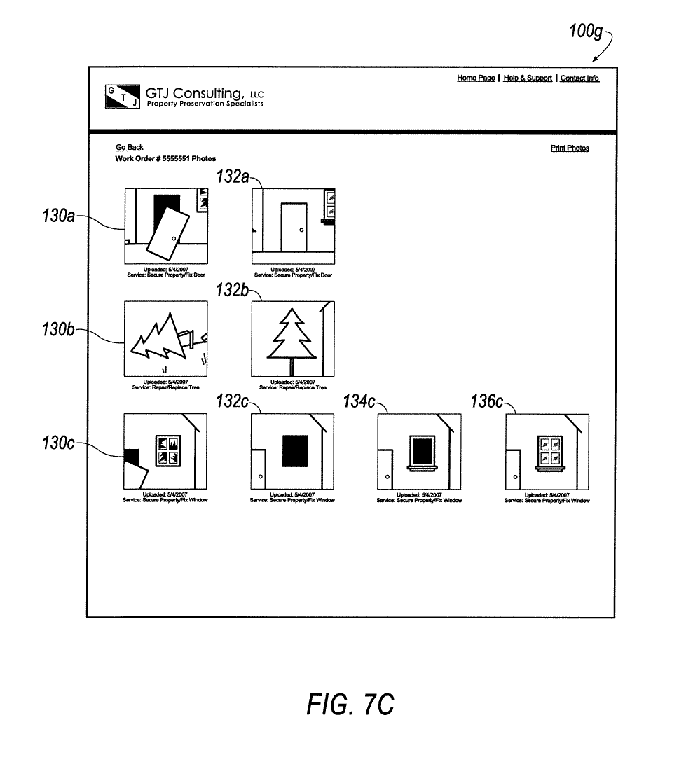

Referring to FIG. 1A, upon creating the one or more virtual work orders, the local agent 30, with the communication device 32, may capture still or moving images 130a-130c (FIG. 7A) of the one or more maintenance needs 36 and upload the still or moving images 130a-130c (step S2.5) associated with the one or more maintenance needs 36 to the database 24. Once uploaded, authorized users of the registered account (e.g., the client 18/agents 26, 30) of the system 10 may select and view the still or moving images 130a-130c associated with the one or more created work orders.

In an embodiment, the uploaded images 130a-130c may be referred to as “before” images due to the fact that no tasks would have yet been completed with respect to the identified maintenance needs 36. In an embodiment, the client 18 and/or agent 26, 30 conducting the uploading step may be required to enter a property address. Then, the website may assign a work order number and date of submission.

C. Reviewing An Entered Work Order

Once the data is uploaded as described above, one may select the “Work Order History” link 108 shown in FIG. 3, and, responsive to selecting this link, a private page 100c of the website is displayed as shown in FIG. 5. In an embodiment, the private page 100c may include a table 114 of work order data. Virtual work order links 116a-116n, each having a unique number, are shown in a first column 118. In an embodiment, the table 114 may include a second column 120 that may be directed to a property address associated with the location 34. In an embodiment, the table 114 may include a third column 122 that may be directed to a submission date of the work order. In an embodiment, the table 114 may include a fourth column 124 that may be directed to a status of the work order.

In an embodiment, the table 114 generally defines a plurality of rows, which are shown generally at 126a-126n. In an embodiment, each row 126a-126n may be read left-to-right and is referenced from a particular work order link 116a-116n.

Although four columns 118-124 and “n” rows 126a-126n are shown in FIG. 5, it will be appreciated that the page 110c is not limited to the above number of columns 118-124 and rows 126a-126n. Further, it will be appreciated that the invention is not limited to a particular unit of data associated with each columns 118-124. It will be appreciated that any desirable number of rows 126a-126n and columns 118-124 having any desirable unit of data in each column 118-124 may be provided as desired.

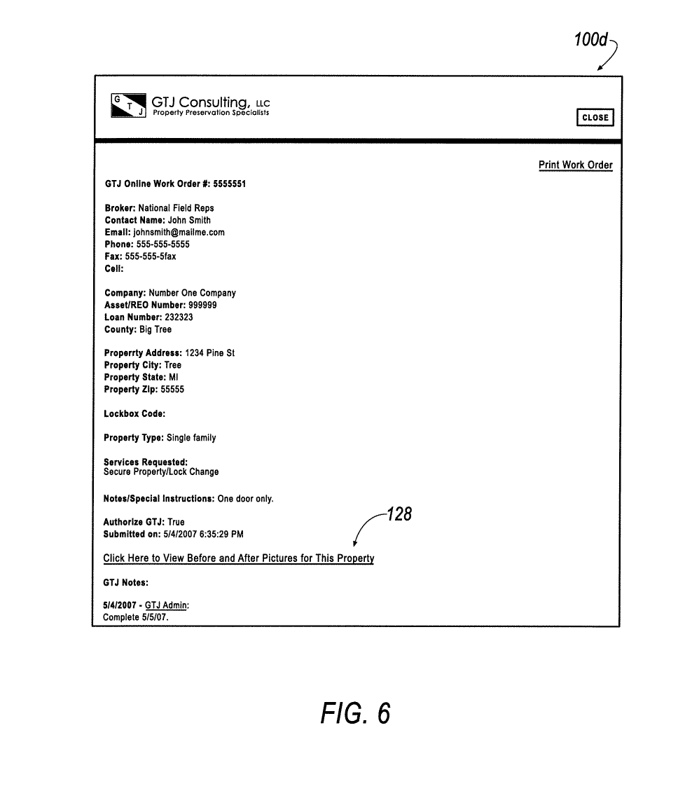

At any time, one or more of the client 18 and agent 26, 30 may select one of the virtual work order links 116a-116n, and, responsive to the selection, another private web page 100d is displayed, as shown in FIG. 6. In an embodiment, the private web page 100d includes, among other things, contact and location data of one or more of the client 18 and/or contact and location data of one or more parties that is/are responsible for completing one or more tasks associated with the maintenance needs 36 of the selected virtual work order 116a-116n. Further, the private web page 100d may include a picture access link, which is shown generally at 128.

Referring to FIG. 7A, when the picture access link 128 is selected, another private web page 100e is displayed. As illustrated, the private web page 100e displays the plurality of “before” images that are shown generally at 130a-130c.

D. Tasking/Editing a Virtual Work Order

In an embodiment, the agent 26, 30 of the administrator portion 14 may personally conduct, or, alternatively, contract to a third party the one or more tasks (step S2.6) associated with the one or more maintenance needs 36. If the tasks are contracted to a third party, the remote agent 30 may periodically investigate the one or more property units 34 to determine if the contractor has completed one or more tasks.

Irrespective of who is responsible for completing the tasks, in an embodiment, the remote agent 30, by utilizing a mobile communication device 32, may capture still or moving images 132a-132c (FIG. 7B) that are to be utilized as evidence of completed tasks associated with the one or more maintenance needs 36. Then, the captured evidence images 132a-132c associated with the completed tasks may be uploaded (step S2.7) to the database 24 for viewing by the authorized users 18, 26, 30.

Referring to FIG. 3, the above described step may be conducted by first selecting the “Edit Work Order” link 106 from the page 100a of the website. In an embodiment, once the evidence images 132a-132c are uploaded, the virtual work order 116a-116n may be said to be edited such that the previously entered “before” images 130a-130c have been updated/changed. In an embodiment, as seen in FIG. 7B, the previous “before” images 130a-130c are retained by the system 10 and the edited/updated “after” images 132a-132c are displayed successively to the right of the “before” images 130a-130c for comparative purposes.

In an embodiment, as seen in FIG. 7C, attention is given to the bottom row of “In Progress” images shown on the page 100g. In addition to the first and second images 130c and 132c, a plurality of successive images 134c and 136c are shown added to the right of the first and second images 130c, 132c. In an embodiment, the images 130c-136c are directed to the repair of a broken window that is ultimately replaced by a picture window.

In relation to FIG. 7C, some representations of a particular maintenance need 36 may not simply be represented by two images, being “before and after” images. Where there are a plurality of tasks that are to be completed over time, a plurality of “In Progress” images 132c, 134c may provide the client 18 with proof of periodic updates to a task. Accordingly, the “In Progress” images 132c, 134c are added successively as tasks are completed until a final, “Completed” image 136c is entered.

Thus, the client 18 may easily track, for example, the progress of the maintenance need 36b by viewing uploaded “In Progress” images related to, for example, the “before,” broken window image (i.e., image 130c). As illustrated, the “In Progress” images may include the demolition of the window (image 132c) and the addition of picture window structure (image 134c). Finally, the client 18 may view the “Completed” picture window (image 136c), which includes the installation of the pane of glass within the structure shown in image 134c.

E. Alerts

If desired, the server 22 may send an alert to the client portion 12 in order to notify the client 18 that one or more tasks (a) has/have not been completed, (b) has/have been completed or is (c) in-progress. The alert may include but is not limited to an automated phone call, an email, text message or the like. It will be appreciated that, in an embodiment, the client 18 may customize an alert setting to receive any type of alert pertaining to the progress or lack thereof for any given task related to any particular maintenance need 36.

In the event than an alert has been sent, or, when periodically investigating the work orders by clicking on the “Work Order History” link 108, the client 18 may view the page 100c and notice that the status indicator column 124 may provide an indication that one or more of the work orders 116a-116n may be, in an embodiment “Not Completed,” “In Progress” or “Completed.” The status indicator of each work order 116a-116n may be manually or automatically updated by the agent 26, 30 in view of the completion of one or more tasks associated with the one or more maintenance needs 36 of each work order 116a-116n. After noticing that one of more of the work orders 116a-116n are “In Progress” or “Completed,” one may select a particular work order link 116a-116n and subsequently arrive at and select the picture access link 128 (see, e.g., FIG. 6) in order to view the updated, “after”/“in progress” images 132a-136c(see, e.g., FIGS. 7B, 7C).

Further, it will be appreciated that upon entry of a maintenance need 36 to the database 24 (e.g., by uploading “before” images) by either the client 18 or agent 26, 30, an associated deadline/completion date may be conjunctively entered (step S2.5a in FIG. 2B) for each maintenance need 36. For example, if a task associated with a maintenance need 36 is to be completed by, for example, “July 30,” and, if no task completion data (e.g. an “after” or “in progress” image showing a completed task entered by the remote agent 30) has been provided to the database 24 by, for example, “July 31,” (steps S2.5b-S2.5c) a lapsed deadline alert may be sent (step S2.5d) to one or more of the client 18 and/or agent 26, 30 such that a sense of urgency may be instilled in one or more of the client 18 and/or agent 26, 30 such that the task may be completed in a timely fashion.

Further, if desired, the agent 26, 30 may enter a reminder date (step S2.5a) such that a reminder alert may be sent to the agent 26, 30 prior to the deadline date. If desired, the reminder date may be manually or automatically calculated and entered into the database 24 in reference to the entered deadline/completion date. Accordingly, if the system 10 determines that a particular task is “Not Completed” or “In Progress,” a reminder alert may be sent (steps S2.5b-S2.5d) to the agent 26, 30 according to the calculated/entered reminder date. As similarly described above, the deadline/completion alert and/or the reminder alert may include but is not limited to an automated phone call, an email, text message or the like.

Yet even further, as “In Progress” or “Completed” images 132a-136c are uploaded, the system 10 may detect (step S2.7a in FIG. 2C) the “In Progress” or “Completed” identifier (from the fourth column 124 of the table 114) that is associated with each image 132a-136c. If, for example, the status identifier is determined to be, for example, “In Progress” or “Completed,” an alert may be sent (step S2.7b) to the client 18 such that the client 18 may be progressively informed as to updates to each work order 116a-116n is provided.

F. Enlarging Before/After Images

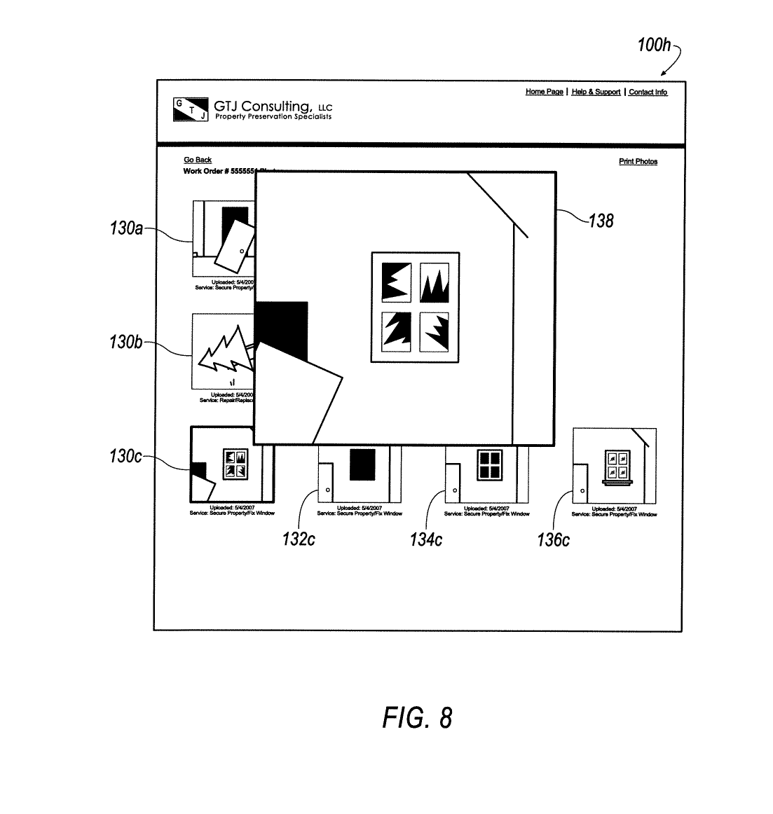

Referring to FIG. 8, the client 18 may select any one of the “before, ” in progress,” or “after” images 130a-136c. In an embodiment, responsive to selecting any of the images 130a-136c, the selected still or moving images 130a-136c may change in appearance from a small/low resolution image (as shown in FIGS. 7A-7C) to a larger/high resolution image 138 (as shown in FIG. 8) on a monitor of the communication device 20, 28, 32. In an embodiment, the image 130c is shown in FIG. 8 as the larger/high resolution image 138.

To enlarge the image 130c as shown in FIG. 8, the selection step may be conducted by moving a cursor over the image 130c on the page 100e-100g and then subsequently “clicking” on the still or moving images 130c. Alternatively, the “clicking” action may not be conducted and the changing in appearance from a small/low resolution image 130c to a larger/high resolution image 138 may be conducted automatically once the cursor is merely positioned over the tiled still or moving image 130c.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. A method for operating a property management system, comprising the steps of:
identifying one or more maintenance needs of one or more real property units; and
utilizing a communication device for
creating one or more virtual work orders related to the one or more maintenance needs,
uploading one or more maintenance need images associated with the one or more virtual work orders, and
uploading one or more serviced task images associated with the one or more virtual work orders.

2. The method according to claim 1, wherein the communication device is further utilized for:
accessing and viewing one or more of the
maintenance need images, and
serviced task images.

3. The method according to claim 2, wherein the accessing and viewing step further comprises the step of:
modifying one or more of the maintenance need and serviced task image from a small, low resolution display image to a large, high resolution display image.

4. The method according to claim 1, wherein the communication device is further utilized for:
receiving an alert

5. The method according to claim 4, wherein the alert includes:
one or more notices that one or more maintenance need tasks are in-progress, or
one or more notices that that one or more maintenance need tasks are completed,

6. The method according to claim 4, wherein, after the creating one or more virtual work order step, the communication device is further utilized for:
entering one or more of
a maintenance need task deadline reminder date, and
a maintenance need task deadline date.

7. The method according to claim 6, wherein the alert includes:
one or more maintenance need task deadline reminders, or
one or more notices of the lapsing of a task deadline.

8. A property management system, comprising:
a client portion; and
an administrator portion, wherein one or more of the client portion and administrator portion includes
means for
creating one or more virtual work orders related to the one or more maintenance needs of one or more real property units,
uploading one or more maintenance need images associated with the one or more virtual work orders, and
uploading one or more serviced task images associated with the one or more virtual work orders.

9. The system according to claim 8, wherein the means includes one or more communication devices, wherein the one or more communication devices includes a computer terminal, a cell phone, or personal digital assistant.

10. The system according to claim 9, wherein the means for further includes:
accessing and viewing one or more of the
maintenance need images, and
serviced task images.

11. The system according to claim 10, wherein the accessing and viewing further comprises:
modifying one or more of the maintenance need and serviced task image from a small, low resolution display image to a large, high resolution display image.

12. The system according to claim 9, wherein the means for further includes:
receiving an alert

13. The system according to claim 12, wherein the alert includes:
one or more notices that one or more maintenance need tasks are in-progress, or
one or more notices that that one or more maintenance need tasks are completed,

14. The system according to claim 12, wherein the means for further includes:
entering one or more of
a maintenance need task deadline reminder date, and
a maintenance need task deadline date.

15. The system according to claim 14, wherein the alert includes:
one or more maintenance need task deadline reminders, or
one or more notices of the lapsing of a task deadline.
